(19) United States
(12) Patent Application Publication
(10) Pub. No.: US 2015/0160938 A1
(43) Pub. Date: Jun. 11, 2015

(54) AUTOMATION IN RULE ENGINE IN AN INTEGRATION DEVELOPMENT ENVIRONMENT

(71) Applicant: FMR LLC, Boston, MA (US)

(72) Inventors: Abraham George, Cary, NC (US); Supritam Sen, Raleigh, NC (US); Shamseer Chettiankandy, Cary, NC (US)

(73) Assignee: FMR LLC, Boston, MA (US)

(21) Appl. No.: 14/101,467

(22) Filed: Dec. 10, 2013

(51) Int. Cl. G06F 9/445

(52) U.S. Cl. CPC G06F 8/65

(57) ABSTRACT

A system for deploying rules engine code to an application server is provided that includes an integrated development environment (IDE) system that receives a compiled rules engine code so as to deploy updates to the application server. A deployment tool is integrated within the IDE that directly deploys the creation of a project file and subsequent loading of the project file into the application server.

### BACKGROUND OF THE INVENTION

The present invention is related to the field of hot deployment of business rule management systems (BRMS), and in particular to a BRMS specifically designed to operate in an Integrated Development Environments (IDEs).

Every company (employer) that needs to manage pension accounts (or pensions) for their employees and wants to leverage the services provided by Fidelity Investments is referred to as a “client”. Plan rules for the client are converted to business rules in the rule engine by the System developers. The business rules management system (BRMS) utilized for developing and housing the repository of rules for each “client” engine is based on the Blaze decision management system or platform developed by FICO. Such systems are deficient in deploying rules engine code to an application server.

### SUMMARY OF THE INVENTION

According to one aspect of the invention, there is provided a system for deploying rules engine code to an application server. The system includes an integrated development environment (IDE) system that receives a compiled rules engine code so as to deploy updates to the application server. A deployment tool is integrated within the IDE that directly deploys the creation of a project file and subsequent loading of the project file into the application server.

According to another aspect of the invention, there is provided a method for deploying rules engine code to an application server. The method includes receiving compiled rules engine code so as to deploy updates to the application server via an integrated development environment (IDE) system. Also, the method includes directly deploying the creation of a project file and subsequent loading of the project file into the application server directly from the IDE system using a deployment tool that is integrated within the IDE.

According to another aspect of the invention, there is provided a non-transitory computer-readable storage medium containing thereon a computer program for deploying rules engine code to an application server. The computer program executes the following steps: receiving compiled rules engine code so as to deploy updates to the application server via an integrated development environment (IDE) system; and directly deploying the creation of a project file and subsequent loading of the project file into the application server using a deployment tool that is integrated within the IDE system.

### BRIEF DESCRIPTION OF THE DRAWINGS

FIG. 1 is a schematic diagram illustrating the typical layout of a developer system and the tools and applications used for the development of rule engines;

FIG. 2 is the flow diagram illustrating a typical client engine rule development process;

FIG. 3 is schematic diagram illustrating the process for hot deploying rule engine code without the inventive hot deploy plug-in used in accordance with the invention;

FIG. 4 is schematic diagram illustrating the process for hot deploying the rule engine code directly to the application server using a plug-in;

FIG. 5 is a schematic diagram illustrating the template instance used for hot deploy automation;

FIG. 6 is a schematic diagram illustrating a template used to create the template instance of FIG. 5; and

FIG. 7 is a schematic diagram illustrating a Deploy Tools Provider used in accordance with the invention.

### DETAILED DESCRIPTION OF THE INVENTION

The invention provides a novel way for the direct deployment of business rules associated with one or more business rules management systems (BRMS) to an application server in Integrated Development Environments (IDEs). The invention uses the Blaze platform that is being housed as part of the Web Logic application server infrastructure. Part of the rules development is done within the Blaze IDE (Integrated Development Environment) or within the Eclipse IDE to develop the Java rules for the client. Once the rules are developed in the Blaze IDE, they need to be “hot” or directly deployed to the application server before these rules can be executed.

The technique for improving the performance of this hot deployment process is the subject of this patent and is only applicable to the Blaze IDE.

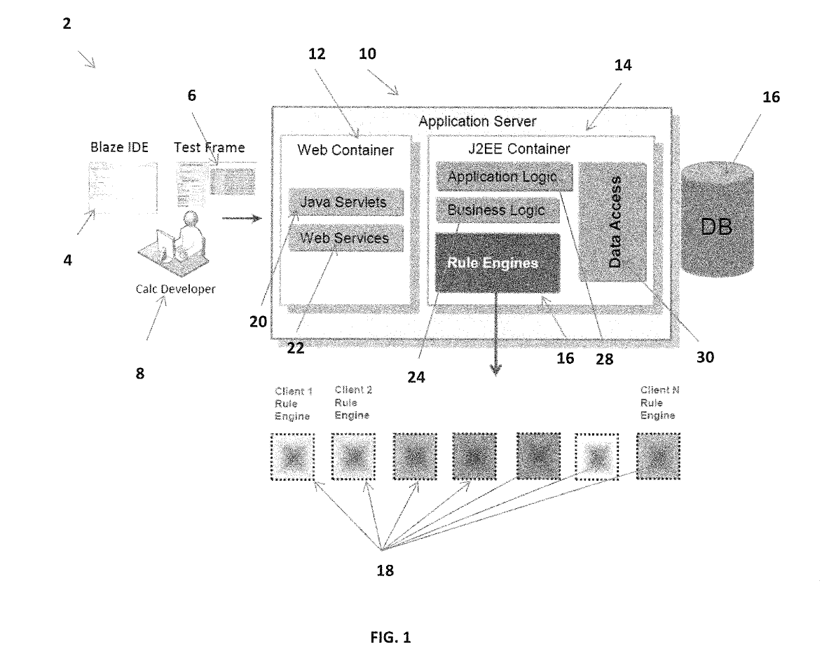

FIG. 1 shows the typical layout 2 of a developer system and the tools and applications used for the development of rule engines. A Calc engine developer 8 uses the Blaze IDE 4 to write the rules for the client and will need to compile and directly deploy the code to the application server 10 before using the “Test Frame” 6 to run a test of the rules engine code. The application server 10 includes a web container 12 and J2EE container 14. The web container 12 includes web services 22 and Java servlets 20. The web container 12 provides such services as request dispatching, security, concurrency, and lifecycle management using web services 22. A web container 12 also gives web components access to such APIs as naming, transactions, and email. Java servlets 20 are best suited for service-oriented applications (web service endpoints can be implemented as servlets) and the control functions of a presentation-oriented application, such as dispatching requests and handling non-textual data. The J2EE container 14 ensures that dynamic business logic can be managed in a consistent and efficient manner using the business logic module 24. The business logic module 24 utilizes the rules engine 18 to access business rules needed for processing. J2EE container 14 manage the application logic 28 for managing business data and applications executing on the application server 10. The data access module 30 is used to access the remote database 18.

The application server 10 takes the test request and invokes the appropriate client rules engine 18 that was directly deployed to that application server 10. The application server 10 typically has more than one client engines 18 deployed.

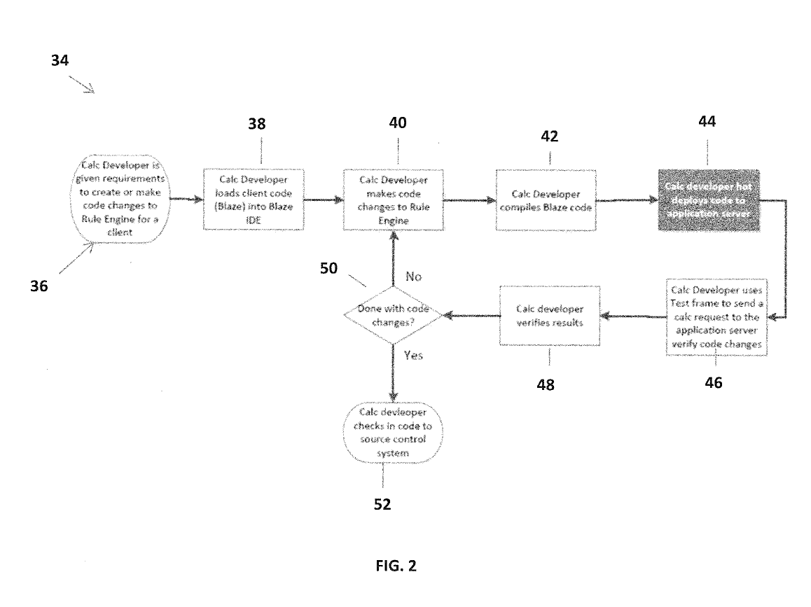

FIG. 2 shows the flow diagram 34 for a typical client engine rule development process. The Calc developer will go into an iterative process of writing rules a small number at a time, compiling and hot deploying the code to the application server before running test cases against the server, as shown in step 36. Given that a typical Calc developer goes through many such iterations throughout the day, it is critical that each step of the process, especially the hot deploy process, needs to be made more efficient. Note the Calc developer loads client code to a Blaze IDE, as shown in step 38. The Calc developer makes code changes to the Rules Engine, as shown in step 40. The Blaze code is then compiled, as shown in step 42. The Calc developer hot or directly deploy the compile code within Blaze IDE to the application server, as shown in step 44. A test frame is used to send a request to the application server to verify code changes, as shown in step 46. The Cale developer verify the results provided back from the application, as shown in step 48. The Calc developer must determine if there are any further changes: if there are repeat step 40 otherwise the Calc developer proceeds

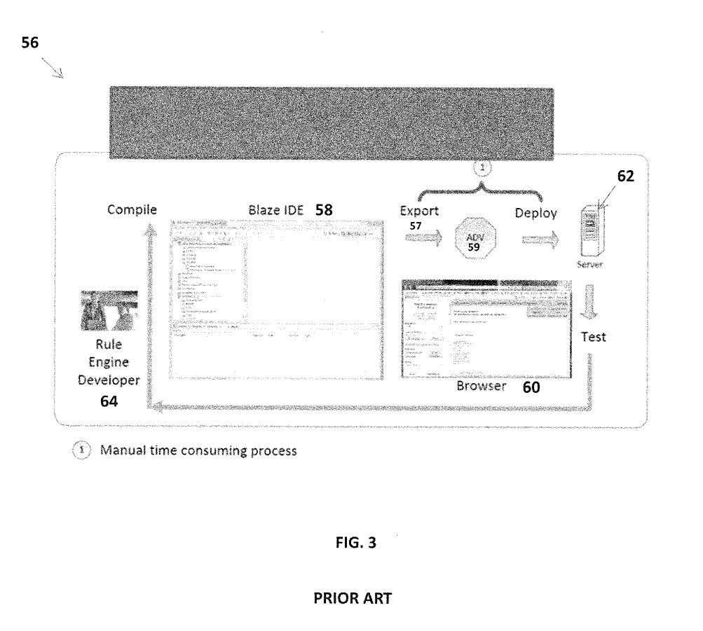

FIG. 3 shows the process 56 for hot deploying rule engine code without the inventive hot deploy plug-in used in accordance with the invention. The rules engine developer 64 compiles rules engine code using Blaze IDE 58 and needs to deploy the updates to the application server 64 for unit testing the changes. The developer 64 review the changes using a browser 60.

This cycle is a repetitive process and is done many times during the day. The hot deploy process 56 is not performed using a deployment manager in the development environment as it is more commonly used in a production environment. The hot deploy process itself was done with an external script that will force the application manager to load (compile and update the memory image of the rules engine) the code changes via a vendor provided API. The load process used to take the code from the flat file code repository and the whole hot deploy process used to take up to several minutes for large complex projects. Recently, the hot deploy process was modified to load the code from an export 57 of the project itself (the ADV file 59). The performance improved somewhat, but because this was a manual process, the performance gains were not substantial.

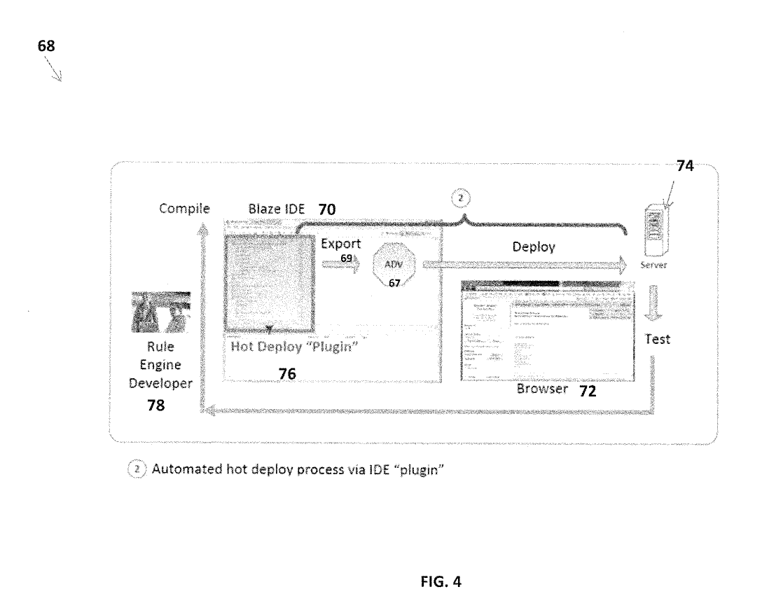

FIG. 4 shows the process 68 for hot deploying the rule engine code directly to the application server 74 using a plug-in 76. The “plug in” 76 was developed to automate the creation of the project (ADV) file 67, using the export function 69, and subsequent loading of the project file 67 into the application server 74 directly from the Blaze IDE 70 with a single click. This allowed the developer 78 to compile code, hot deploy and test in a very short period of time thus dramatically improving developer 78 productivity as a result of this automated process. The developer 78 never has to step out of the IDE during the entire iteration cycle during their development activities. The “plugin” 76 itself resides side by side with the code in the IDE 70 and has no adverse side effects on the performance of the IDE 78 or the rules engine.

The technique introduced to improve performance is the use of a custom “provider” that is a feature enabled by the Blaze platform. A custom provider to speed up the hot deploy process was developed and added as a plug-in to the client rules engine.

The first step that the custom provider would take is to export the project being used for the client rules engine to a location that is used by the application server to load the client rule engine code. The next step in the automation process is for the custom provider to send a special request to the application server to “load” the new/updated rules engine code into the application server. This is the final step of the hot deploy process when the Blaze engine within the application server would reset the state of the rules engine within the application server.

The custom provider is written in Java code using the Blaze platform provided API. The Java code is attached to custom Blaze “information” templates which are “instantiated” and presented in the UI of the IDE for the user to invoke.

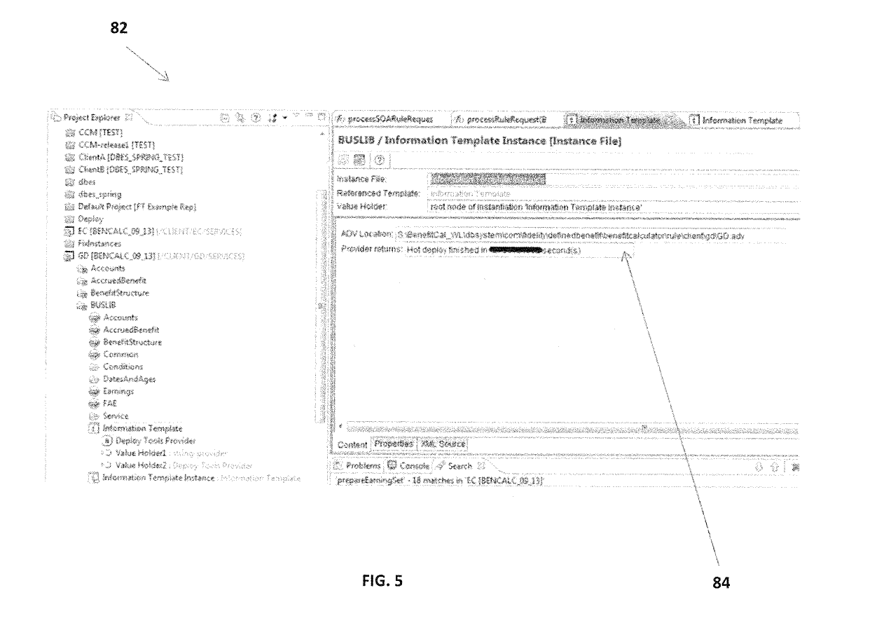

FIG. 5 shows the template instance 84 used for hot deploy automation. Every client project developed within the IDE can take advantage of this template instance 82 to aid with the hot deploy automation process. The user will just have to open the instance to trigger the hot deploy automation. The path 84 to the project file is already defaulted to the correct location and the time taken to hot deploy is returned in the adjacent field.

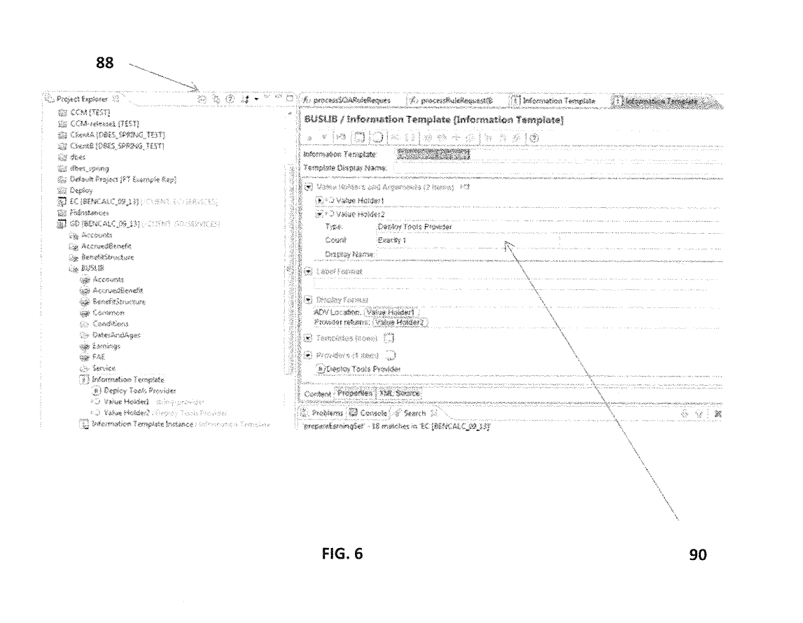

FIG. 6 shows the template 88 used to create the template instance 84. You can see that a Deploy Tools Provider is used as one of the “value holders” 90 in the template 88. The Deploy Tools Provider is explained hereinafter. The template 88 is created first and it is designed to use the Deploy Tools Provider. An instance of this template 88 has to be created (and its purpose was explained in the previous paragraph) in order for the hot deploy automation to function.

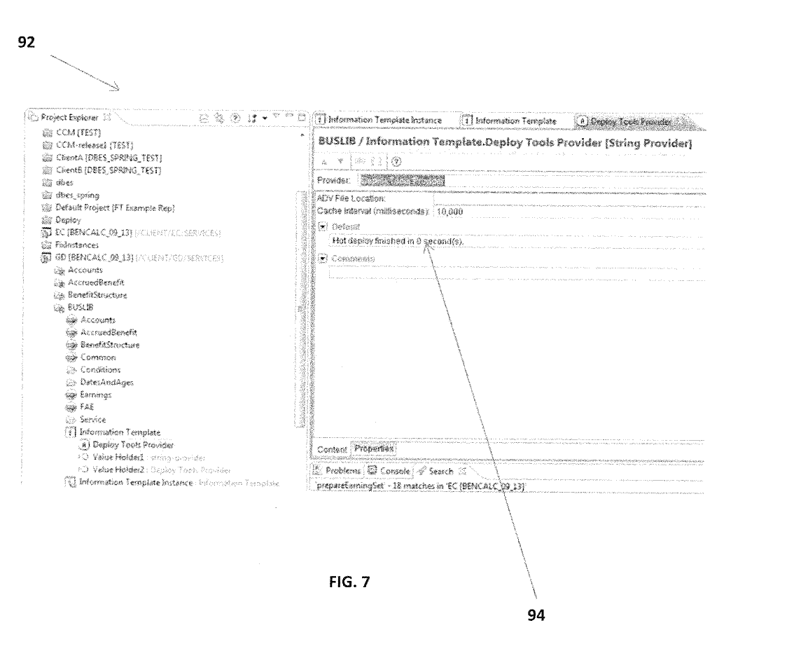

FIG. 7 shows the Deploy Tools Provider 92 and it is a provider that uses the Java class that has the implementation code for the hot deploy automation process. The provider 92 instantiates the java class and passes required parameters to the class 94. Once the Java class is instantiated by this provider 92, it will initiate the export of the project and trigger a HTTP call to the application server to load and reset the rules engine code from that project location.

The invention describes a novel way for the direct deployment of a business rule within an Integrated Development Environments (IDEs) to an application. The invention uses a Blaze platform or the like where rules development is done within an IDE (Integrated Development Environment) of a client permitting “hot” or direct deployment of the rules engine code to the application server before these rules can be executed.

Although the present invention has been shown and described with respect to several preferred embodiments thereof, various changes, omissions and additions to the form and detail thereof, may be made therein, without departing from the spirit and scope of the invention.

What is claimed is:

1. A system for deploying rules engine code to an application server comprising:
an integrated development environment (IDE) system executing on the application server that receives a compiled rules engine code so as to deploy updates to the application server; and
a deployment tool that is integrated within the IDE system executing on the application server directly deploys the creation of a project file and subsequent loading of the project file into the application server, wherein the compiled engine code is exported to a local file and a web request is sent to the application server to trigger the deployment using the deployment tool for purposes of testing and updating the local file, the deployment tool permits direct deployment of the compiled rules engine code to the application server before specific rules are executed.

2. The system of claim 1, wherein the deployment tool comprises a plug-in executed within the IDE system.

3. The system of claim 1, wherein the IDE system executes an export function to produce the project file.

4. The system of claim 1, wherein the project file uses a first predefined template to initiate the deployment tool.

5. The system of claim 4, wherein the first predefined template uses a second predefined template to create an instance of itself.

6. The system of claim 1, wherein the deployment tool comprises a deployment provider that initiates the export of the project file and trigger a HTTP call to the application server to load and reset the rules engine code from that project file location.

7. A method for deploying rules engine code to an application server comprising:
receiving compiled rules engine code so as to deploy updates to the application server via an integrated development environment (IDE) system; and
directly deploying the creation of a project file and subsequent loading of the project file into the application server using a deployment tool that is integrated within the IDE, wherein the compiled engine code is exported to a local file and a web request is sent to the application server to trigger the deployment using the deployment tool for purposes of testing and updating the local file, the deployment tool permits direct deployment of the compiled rules engine code to the application server before specific rules are executed.

8. The method of claim 7, wherein the deployment tool comprises a plug-in executed within the IDE system.

9. The system of claim 7, wherein the IDE system executes an export function to produce the project file.

10. The method of claim 7, wherein the project file uses a first predefined template to initiate the deployment tool.

11. The method of claim 10, wherein the first predefined template uses a second predefined template to create an instance of itself.

12. The method of claim 7, wherein the deployment tool comprises a deployment provider that initiates the export of the project file and trigger a HTTP call to the application server to load and reset the rules engine code from that project file location.

13. A non-transitory computer-readable storage medium containing thereon a computer program for deploying rules engine code to an application server comprising:
receiving compiled rules engine code so as to deploy updates to the application server via an integrated development environment (IDE) system; and
directly deploying the creation of a project file and subsequent loading of the project file into the application server using a deployment tool that is integrated within the IDE system, wherein the compiled engine code is exported to a local file and a web request is sent to the application server to trigger the deployment using the deployment tool for purposes of testing and updating the local file, the deployment tool permits direct deployment of the compiled rules engine code to the application server before specific rules are executed.

14. The non-transitory computer-readable storage medium of claim 13, wherein the deployment tool comprises a plug-in executed within the IDE system.

15. The non-transitory computer-readable storage medium of claim 13, wherein the IDE system executes an export function to produce the project file.

16. The non-transitory computer-readable storage medium of claim 13, wherein the project file uses a first predefined template to initiate the deployment tool.

17. The non-transitory computer-readable storage medium of claim 16, wherein the first predefined template uses a second predefined template to create an instance of itself.

18. The non-transitory computer-readable storage medium of claim 13, wherein the deployment tool comprises a deployment provider that initiates the export of the project file and trigger a HTTP call to the application server to load and reset the rules engine code from that project file location.
